(19) United States
(12) Patent Application Publication
(10) Pub. No.: US 2004/0244145 A1
(43) Pub. Date: Dec. 9, 2004

(54) Hinge

(76) Inventor: Joseph Anscher, Muttontown, NY (US)

Correspondence Address: WILLIAM COLLARD, COLLARD & ROE, P.C., 1077 NORTHERN BOULEVARD, ROSLYN, NY, 11576, US

(21) Appl. No.: 10/648,921

(22) Filed: Aug. 27, 2003

Related U.S. Application Data
(63) Continuation-in-part of application No. 10/453,949, filed on Jun. 4, 2003.

(51) Int. Cl. E05D 11/00

(52) U.S. Cl. 16/222

(57) ABSTRACT

A hinged product has a first section and a second section. The first section has a post extending transversely across one end thereof. The second section two co-axial apertures therein, each of the apertures having an internal wall. The post extends between and through the apertures to connect the first section to the second section. The first section is integrally formed with the second section via at least one connection point connecting the first section and the second section outside of the apertures. Rotating the first section relative to the second section causes the connection point to break and create a two piece hinge.

### CROSS REFERENCE TO RELATED APPLICATIONS

This is a continuation-in-part of U.S. patent application Ser. No. 10/453,949 filed on Jun. 4, 2003.

### BACKGROUND OF THE INVENTION

1. Field of the Invention

The invention relates to a hinge that is suitable for many uses, but is particularly suitable for use in rod clips that hold metal rods inside the door mechanisms of automobiles. In particular, the invention relates to a hinge that can be molded in one piece and subsequently snapped into two pieces for use.

2. The Prior Art

It is well known in the automotive industry to use rod clips to connect actuating rods to levers. This type of arrangement is especially common with door locking mechanisms and carburetor linkage arrangements. The clips are typically made of a plastic material and snap around the end of the rod. The lever is then snapped into a protrusion on the clip having a retaining lip or latches on its sides.

The clips can be manufactured as one piece with an integral “living hinge” or in two pieces with a connection mechanism connecting the two pieces. In general, the two-piece constructions are more durable, but can be difficult to mold and assemble because of the separate pieces.

In addition, the two-piece hinges generally have a lot of play between the two parts, and the interaction between the two parts is very loose.

One hinge construction is shown in U.S. Pat. No. 6,053,458 to Meyer, which shows a hinge that is integrally molded in one piece via radially extending fingers within the apertures that hold the post in place.

### SUMMARY OF THE INVENTION

It is an object of the invention to provide a rod clip or other item having a two-piece hinged construction that can be molded in one step and not require assembly, and which does not have too much play between the two parts.

The invention comprises a hinged product having a first section and a second section. The first section has a post extending transversely across one end. The second section has two co-axial apertures therein, each of the apertures having an internal wall. The post on the first section extends through the apertures in the second section to connect the first section to the second section.

The first section is integrally formed with the second section via at least one connection point. Rotating the first section relative to the second section causes the connection point or points to break. Thus, a two-piece hinge can be manufactured as a single piece. In a preferred embodiment, the connection point is formed via a protrusion on a side wall of the first section, located above the post. This protrusion is initially integrally formed with an inner side wall of the second section, just outside the aperture. Rotating the first portion relative to the second portion causes the connection point to break and create a two-piece hinge.

In a second preferred embodiment, the connection point is formed by a rib that extends radially along the inner side wall of the second section, just outside the aperture. This rib connects to a rear portion of the first section, just beyond the post, opposite from the side of the first section that pivots. Rotating the first section relative to the second section causes the rib to break contact with the first section, or with the second section.

In a third preferred embodiment, the connection point is formed by a protrusion extending radially from the second section to the post, outside the aperture. Rotating the first section relative to the second section causes the protrusion to break, preferably at the point where it connects to the post.

The hinge according to the invention is useful in many different products. It is particularly useful in a rod clip, such as that shown in U.S. patent application Ser. No. 10/187,663 to Joseph Anscher, the disclosure of which is herein incorporated by reference.

In a preferred embodiment, the post and aperture could have a plurality of ribs and protrusions arranged in the space between the post ends and aperture walls, creating a stepped-like rotation between the two sections. This feature is disclosed in U.S. patent application Ser. No. 10/453,949, which is herein incorporated by reference.

The product according to the invention could be formed of any suitable material, such as injection-molded plastic.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of a first embodiment of the hinge according to the invention;

FIG. 2 shows an enlarged view of the connection point of the hinge of FIG. 1;

FIG. 3 shows a top view of the hinge of FIG. 1;

FIG. 4 shows a cross-sectional view along lines III-III of FIG. 3;

FIG. 5 shows a perspective view of another embodiment of the hinge according to the invention;

FIG. 6 shows an enlarged view of the connection point in the hinge according to FIG. 5;

FIG. 7 shows a top view of the hinge according to FIG. 5;

FIG. 8 shows a cross-sectional view along lines VIII-VIII of FIG. 7;

FIG. 9 shows a perspective view of a third embodiment of the hinge according to the invention;

FIG. 10 shows an enlarged view of the connection point in the hinge according to FIG. 9;

FIG. 11 shows a top view of the hinge of FIG. 8; and

FIG. 12 shows a cross-sectional view along lines XII-XII of FIG. 11.

### DETAILED DESCRIPTION OF THE PREFERRED EMBODIMENT

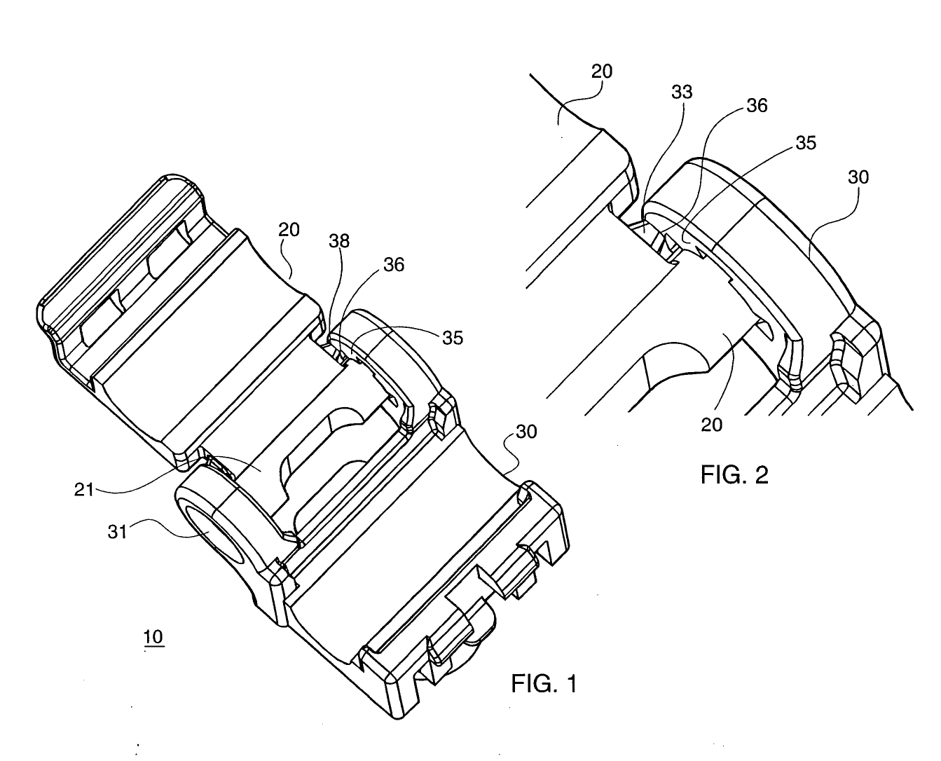

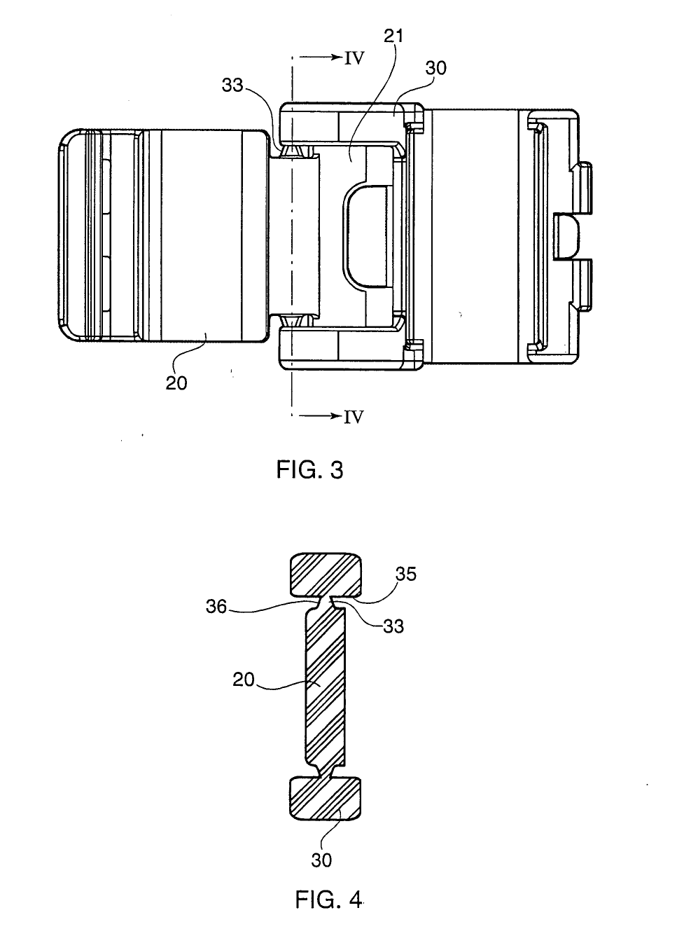

Referring now in detail to the drawings, FIGS. 1-4 show a preferred embodiment of the hinge 10 according to the invention. Hinge 10 comprises a first section 20 that is hinged to a second section 30. First section 20 has a post 21 that extends through two co-axial apertures 31 on second section 30. Each aperture 31 has an inside wall 32 extending all around.

The entire hinge 10 is molded integrally as one piece, with connection points 36 connecting first section 20 to second section 30. Connection points 36 extend out from protrusions 33 located on first section 20 and connect directly to inner-facing wall 35 on second section 30. This way, a single mold is required to create the entire product, and no assembly is required. To use the hinge, connection points 36 are broken by rotating first section 20 relative to second section 30 until connection points snap. Then, the two sections are permanently separated from each other and function as a two-piece hinge.

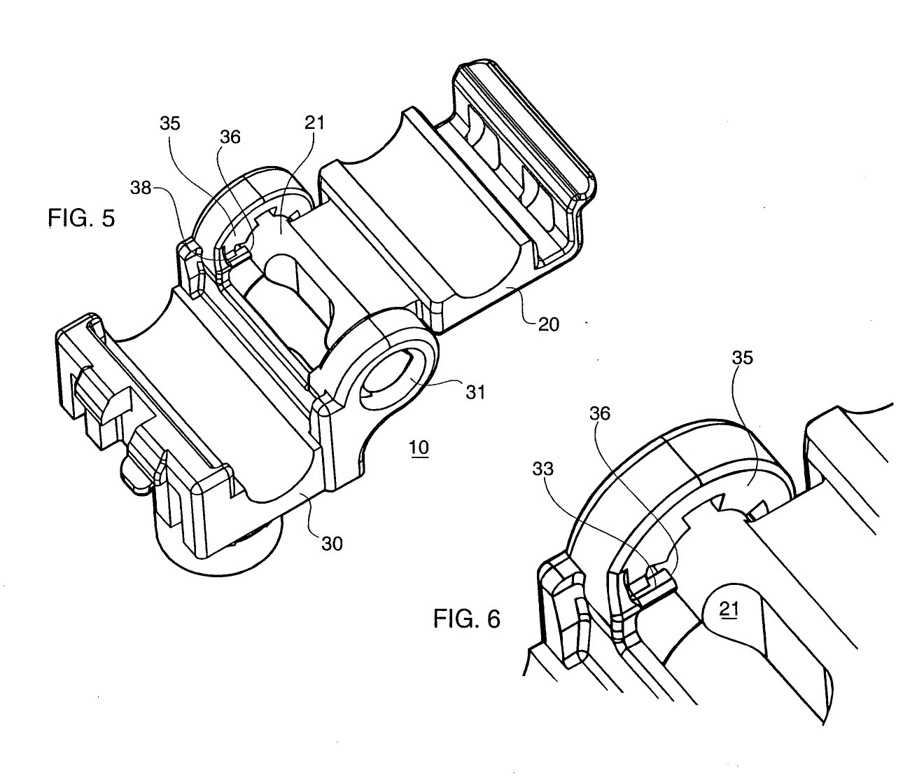

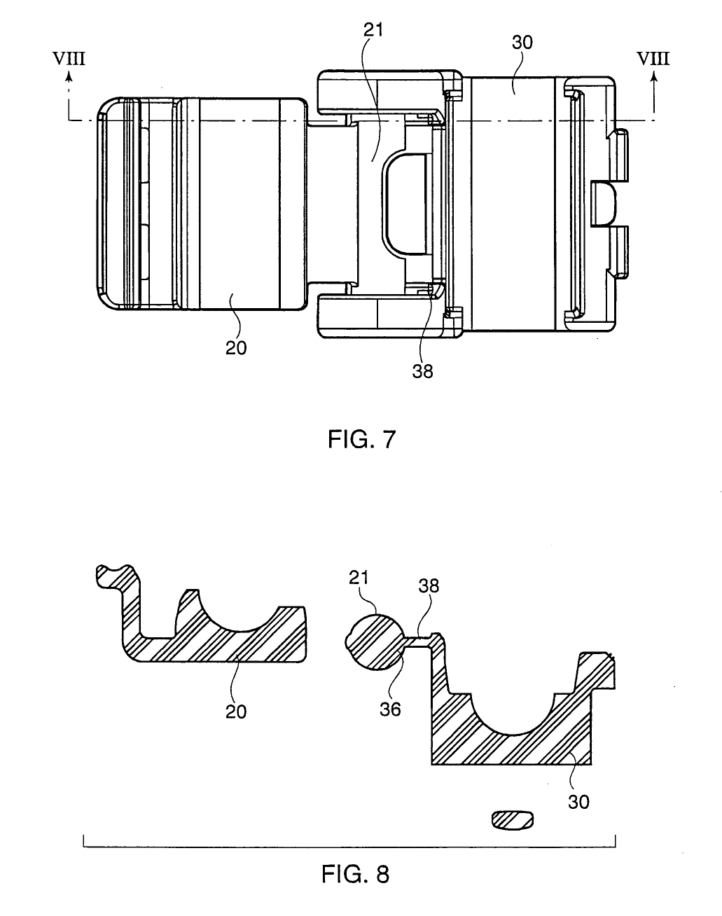

FIGS. 5-8 show an alternative embodiment of the hinge 10 according to the invention. Here, connection point 36 is formed by a rib 38 disposed on second section 30 and connected to post 21 on first section 20. This connection is located opposite the main pivoting portion of first section 20, behind post 21. Rib 38 extends along inner-facing wall 35 of second section 30, outside aperture 31.

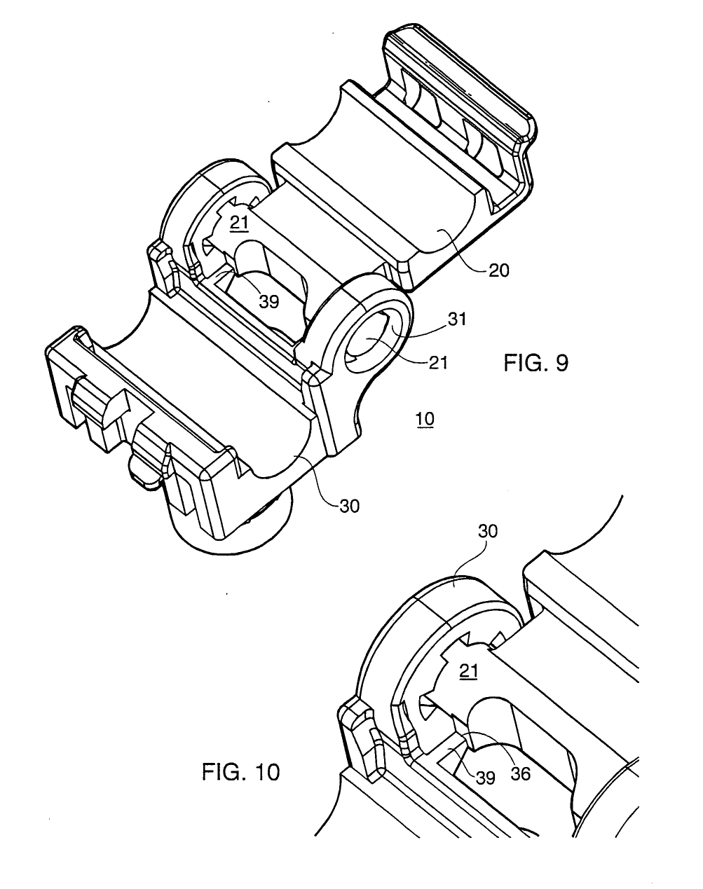

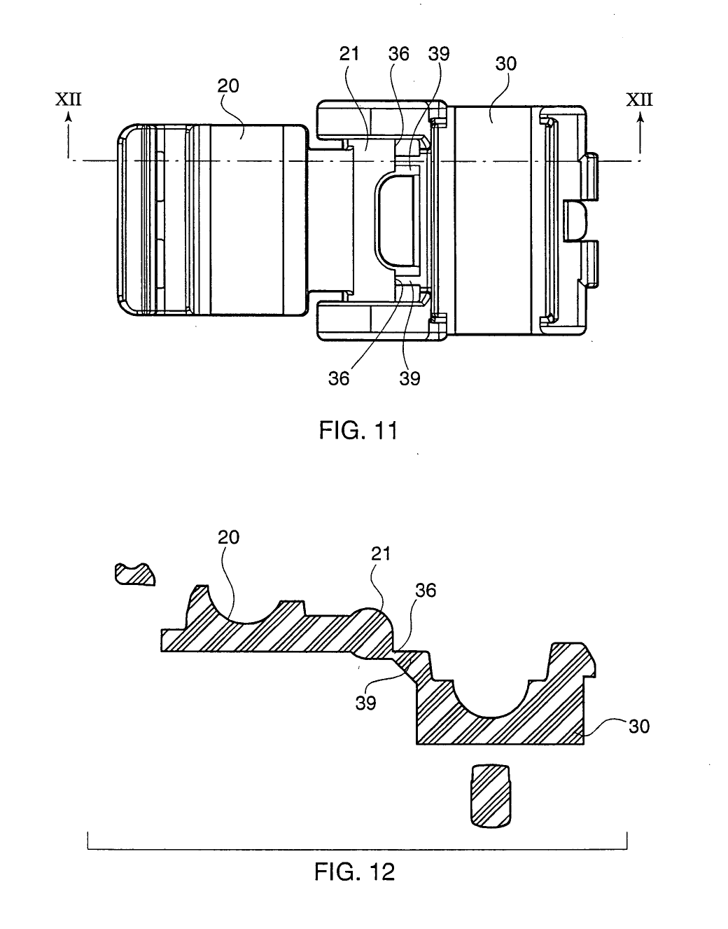

A third embodiment of hinge 10 is shown in FIGS. 9-12. In this embodiment, connection point 36 is formed by a protrusion 39 extending out from second section 30 and connecting to rib 21 on first section 20. Rotating-first section 20 relative to second section 30 causes protrusion 39 to break at connection point 36 to create a two-piece hinge.

Accordingly, while only a few embodiments of the present invention have been shown and described, it is obvious that many changes and modifications may be made thereunto without departing from the spirit and scope of the invention.

What is claimed is:

1. A hinged product comprising:
a first section having a post extending transversely across one end thereof;
a second section having two co-axial apertures therein, each of said apertures having an internal wall, wherein the post on the first section extends through the apertures in the second section to form a pivot between the first section to the second section;
wherein the first section is integrally formed with the second section via at least one connection point connecting the first section and the second section outside of said apertures, wherein rotating the first section relative to the second section causes the at least one connection point to break.

2. The hinged product according to claim 1, wherein the at least one connection point is formed by a protrusion on a side wall of the first section, adjacent the post, said protrusion being initially integrally formed with an inner side wall of the second section, just outside the aperture, such that rotating the first section relative to the second section causes the connection point to break and create a two-piece hinge.

3. The hinged product according to claim 1, wherein the connection point is formed by a rib that extends radially along an inner side wall of the second section, outside the aperture, and connects to a rear portion of the first section behind the post, such that rotating the first section relative to the second section causes the rib to break contact with one of the first section and second section.

4. The hinged product according to claim 1, wherein the connection point is formed by a protrusion extending radially from the second section to the post, outside the aperture, such that rotating the first section relative to the second section causes the protrusion to break and create a two-piece hinged product.
